(19) United States
(12) Patent Application Publication
(10) Pub. No.: US 2026/0365914 A1
(43) Pub. Date: Nov. 19, 2026

(54) CHELATING AGENT COMPOSITIONS AND PROCESSES FOR TREATING STABLE EMULSIONS IN PRODUCED FLUIDS

(71) Applicant: CHEVRON U.S.A. INC., San Ramon, CA (US)

(72) Inventors: Gayani Wasana PINNAWALA, Katy, TX (US); Sujeewa S. PALAYANGODA, Katy, TX (US); Emily Burdett TAO, Katy, TX (US)

(21) Appl. No.: 19/753,619

(22) Filed: Jul. 24, 2026

Related U.S. Application Data
(63) Continuation-in-part of application No. 19/042,790, filed on Jan. 31, 2025, now Pat. No. 12,703,822.
(63) Continuation-in-part of application No. 19/430,698, filed on Dec. 23, 2025.
Application No. 19/430,698 is a continuation of application No. 18/439,282, filed on Feb. 12, 2024, now Pat. No. 12,528,982.
Application No. 18/439,282 is a continuation of application No. 17/121,333, filed on Dec. 14, 2020, now Pat. No. 11,898,100.
(60) Provisional application No. 62/948,258, filed on Dec. 14, 2019.
(60) Provisional application No. 63/548,690, filed on Feb. 1, 2024.
(60) Provisional application No. 63/561,652, filed on Mar. 5, 2024.

(51) Int. Cl. C09K 8/86; C10G 33/04

(52) U.S. Cl. CPC C09K 8/86; C10G 33/04; C09K 2208/26

(57) ABSTRACT

The present application is directed to employing one or more chelates to facilitate either (1) breaking the formation of a foam, an emulsion, or any combination thereof; or (2) inhibiting the formation of a foam, an emulsion, or any combination thereof. The application describes both methods and reaction mixtures that employ chelating agents such as, for example, ethylenediaminetetraacetic acid, tetrakis (hydroxymethyl) phosphonic acid, diethylenetriaminepentaacetic acid, glutamic acid diacetic acid, and methylglycine diacetic acid, citric acid, aminotris(methylenephosphonic acid), 1-hydroxyethylidene-1,1-diphosphonic acid, diethylenetriaminepenta(methylenephosphonic acid), or any salts or mixtures thereof.

### CROSS-REFERENCE TO RELATED APPLICATIONS

The present application is a continuation-in-part of Ser. No. 19/042,790 filed Jan. 31, 2025 published as US2025/0250478 which application claims priority from Ser. No. 63/548,690 filed Feb. 1, 2024 and 63/561,652 filed Mar. 5, 2024, which applications are all incorporated herein by reference.

The present application is also a continuation-in-part of Ser. No. 19/430,698 filed Dec. 23, 2025 which application is a continuation of Ser. No. 18/439,282 filed Feb. 12, 2024 which is now issued U.S. Pat. No. 12,528,982 which application is a continuation of Ser. No. 17/121,333 filed Dec. 14, 2020 which is now issued U.S. Pat. No. 11,898,100 which application claims priority to Ser. No. 62/948,258 filed Dec. 14, 2019, which applications are all incorporated herein by reference.

### FIELD OF THE INVENTION

This application relates to employing one or more chelates to facilitate either (2) breaking the formation of a foam, an emulsion, or any combination thereof; or (2) inhibiting the formation of a foam, an emulsion, or any combination thereof.

### BACKGROUND

The continuous production of relatively stable emulsions remains a persistent challenge in oil field operations. These emulsions can cause formation damage and reduced productivity in downhole environments, lead to pumpability issues and freezing events in flowlines, and/or disrupt separation processes at surface facilities, resulting in off-spec crude oil or produced water. In the case of emulsions, there is often a desire to break these emulsions to separate the hydrocarbon phase for processing and use in downstream applications. Likewise, there is often a need to break foams during the course of hydrocarbon recovery and processing. To accomplish these ends, improved compositions and methods for breaking foams and emulsions are needed. What's more, it would also be advantageous if the formation of such emulsions and/or foams could be inhibited or delayed.

### SUMMARY OF THE INVENTION

The compositions and methods described herein often address these and/or other needs. In one embodiment, the application pertains to methods of breaking or inhibiting the formation of a foam, an emulsion, or any combination thereof. The methods comprise introducing a composition comprising a chelating agent into a produced fluid. The compositions are introduced under conditions to break or inhibit the formation of a foam, an emulsion, or any combination thereof.

In another embodiment, the application pertains to a reaction mixture. A suitable reaction mixture comprises (1) a foam, an emulsion, or any combination thereof; (2) produced fluid; (3) a breaking agent; (4) an emulsion stabilizing amount of one or more metal ions; and (5) one or more chelating agents wherein the total amount of chelating agents is in a molar amount of from about 1 to about 10 times the molar amount of the emulsion stabilizing amount of one or more metal ions.

In another embodiment, the application pertains to a method of breaking a foam, emulsion, or any combination thereof. The method comprises contacting the foam, emulsion, or any combination thereof with a breaking composition and a chelating agent such as EDTA. The breaking composition comprises a sulfosuccinate and a solvent. The solvent has an octanol/water partition coefficient ([P]) at 25°, and wherein the log of the partition coefficient at 25° (log[P]) is from 0.1 to 5.

### BRIEF DESCRIPTION OF THE DRAWINGS

FIG. 1 shows comparison of Example 1 sample with EDTA chelating agent versus Comparative Example 1 without EDTA chelating agent.

FIG. 2 shows comparison of a comparative sample with only B9 emulsion breaker versus a sample with B9 and EDTA chelating agent.

FIG. 3 shows a comparison of an emulsion breaker with and without chelating agent.

FIG. 4 shows two samples with chelating agent that give a sharp interphase compared to sample without the chelating agent.

### DETAILED DESCRIPTION OF THE INVENTION

### General Processes and Compositions

In one embodiment, the application pertains to methods of breaking or inhibiting the formation of a foam, an emulsion, or any combination thereof using, for example, compositions or reaction mixtures described here. Such emulsions and/or foams often tend to form in wellbores during the extraction of oil, gas, and mixtures thereof. The methods and reaction mixtures here employ one or more chelating agents to mitigate emulsion or foam formation. Alternatively or additionally, one or more chelating agents can be employed prior to or simultaneously with a breaking composition such as described in the related applications above that are incorporated by reference. In this manner, the foam or emulsion may be broken more expediently and/or more effectively than with breaking compositions employed in the absence of the one or more chelating agents. In some instances, emulsions cannot be broken at all in the absence of the chelating agents described here. Such methods may increase hydrocarbon production in, for example, an unconventional well or a conventional well.

The method of employing the one or more chelating agents is not particularly critical so long as it contacts produced fluid to hinder and/or mitigate foam or emulsion formation. Similarly, if the emulsion or foam has already formed or begun to form in the produced fluid, then the one or more chelating agents should be employed in a manner such as to contact the formed or forming emulsion or foam to hinder, mitigate, and/or break the emulsion or foam.

The specific manner of contacting the one or more chelating agents and the produced fluid is not particularly critical. Typically, the conditions are selected such that the foam or emulsion is broken or inhibited, hindered or delayed from forming due to the presence of the one or more chelating agents. The one or more chelating agents generally function by scavenging metal ions to grasp the metal ions and prevent their reactivity through one or more and typically multiple bonding sites on the one or more chelating agents. In this manner the metal ions cannot facilitate the formation of emulsions and/or foams or in the case of already-formed emulsions or foams, the bound metal ions cannot strengthen and may weaken the formed or forming emulsion or foam.

Typically, the chelating agent is introduced into a produced fluid under appropriate conditions. The introduction into the produced fluid may be at any convenient place in the production. In some embodiments, the introduction is at the well head and/or the produced flow line. If a breaking composition is also to be employed, then the chelating agent may be introduced prior to, simultaneous with, or subsequent to the breaking composition. Suitable breaking compositions that could be employed prior to, simultaneous with, or subsequent to introducing a chelating agent are described in, for example, US2025/0250478 and U.S. Pat. No. 12,528,982. In a similar manner, the use of such chelating agents and/or breaking compositions can be used before and/or after oil/gas production has begun. In some embodiments, the introduction of chelating agents begins upon or after a determination that a produced fluid may have a problematic amount of a metal, e.g., greater than 10 ppm iron as discussed below. Such metals may originate from the formation or even in certain cases result due to or from injected fluids. In some embodiments, formation brine is tested for metals such as iron. Such metal testing may be done in any convenient manner and in some instances commercially available test strips can be used. If test results show greater than about 10 ppm metal such as iron or higher, then chelating introduction may be proactively initiated prior to production. This may be particularly useful in the event of the possibility of potential stable emulsion formation due to emulsion containing materials present with flowback fluids, frac fluid, and/or wax which in the presence of metals such as iron at 10 ppm or higher can be even more problematic due to very stable emulsions slowing or preventing hydrocarbon production.

Thus, reaction mixtures formed may comprise (1) a foam, an emulsion, or any combination thereof; (2) produced fluid; (3) a breaking agent; (4) an emulsion stabilizing amount of one or more metal ions; and (5) one or more chelating agents. The amount of chelating agent employed may vary depending upon the specific chelating agent and its efficiency in a particular composition, the metals to be chelated and/or their oxidation state, the amount of metals, and the components of the emulsion or foam. Generally, the total amount of chelating agents is in a molar amount of from about 1, or from about 2, or from about 3, up to about 7, or up to about 8, or up to about 10, or up to about 15 times or more of the molar amount of the emulsion stabilizing amount of one or more metal ions. If, for example, other ions are present besides the metal to be scavenged such as iron, then it may be useful to employ a higher molar amount of the chelating agent.

Of course, the weight ratios of chelating agent to emulsion stabilizing amount of one or more metal ions will vary depending upon the weight of the specific chelating agent and metals. However, one of skill may employ the molar ratios above to determine a suitable weight ratio. For example, when employing EDTA to treat an emulsion with 20 ppm iron, then a stoichiometric amount of EDTA would be about 100 ppm. Thus, from about 5, or from about 10, or from about 20 up to about 70, or up to about 60, or up to about 50 weight percent of EDTA based on the total weight of EDTA and metal.could be employed. In such a reaction mixture, the one or more chelating agents may react with the one or more metal ions to from complexes so that the metal ions cannot strengthen any emulsion or foam formed or forming.

### Chelating Agents and Amounts

The specific chelating agent or agents employed and their amounts may depend upon, for example, the type and amount of metal ions present, the composition and nature of the produced fluid, the breaking agents employed, if any, and/or the strength and type of emulsion or foam to be inhibited and/or broken.

Often the methods and reaction mixtures employing chelating agents described here are effective when a produced fluid from the subterranean formation comprises an emulsion stabilizing amount of one or more metal ions. By “emulsion stabilizing amount” is meant at least an amount of metal ions that makes formed emulsions or foams in the produced fluid more stable than in the absence of the emulsion stabilizing amount of one or more metal ions.

The specific metals and amounts in the one or more metal ions that may facilitate emulsion stability vary depending upon the emulsion and potentially the surrounding produced fluid composition. Typical metal ions that tend to make emulsions more stable have been discovered to include, for example, ferrous ions, ferric ions, and mixtures thereof. Such iron ions are often found in subterranean formations wherein produced fluids are extracted. While the source of the iron ions is not particularly important, the iron ions often may originate from FeS or similar compounds present in the subterranean formation. An emulsion stabilizing amount of one or more metal ions that are iron often comprises greater than about 10 ppm, or greater than about 15 ppm, or greater than about 20 ppm, or greater than about 25 ppm, or greater than about 40 ppm, or greater than about 50 ppm, or greater than about 100 ppm, or greater than about 200 ppm, or even up to about 400 pm or higher of metal ions such as iron in the produced fluid. Of course, emulsion stabilizing amounts of metals are particularly problematic in the presence of other components that facilitate stable emulsions such as some flowback and frac fluids and/or the presence of wax.

The specific chelating agent may vary depending upon the metal ion or ions present and their concentration. Iron may be one of the most prevalent metal ions that may lead to greater emulsion stability in produced fluids in subterranean formations. Representative iron chelating agents may include, for example, ethylenediaminetetraacetic acid (EDTA), tetrakis (hydroxymethyl) phosphonic acid, diethylenetriaminepentaacetic acid, glutamic acid diacetic acid, and methylglycine diacetic acid, citric acid, aminotris(methylenephosphonic acid), 1-hydroxyethylidene-1,1-diphosphonic acid, diethylenetriaminepenta(methylenephosphonic acid), or any salts or mixtures thereof. Such chelating agents may be present with water or in the case of tetrakis (hydroxymethyl) phosphonic acid may be in the form of a chloride salt with water and formaldehyde. In the event that other metal ions are causing emulsion stability, an ordinary artisan may conduct some simple tests such as those described in the example below to determine the relative effectiveness of various potential chelating agents.

Citric acid and other mild iron chelating agents are usually less preferred. Should citric acid and/or other mild iron chelating agents be employed, then they are generally employed in much higher amounts than when citric acid is employed in frac fluid. That is, in certain embodiments herein citric acid is employed at greater than about 120 ppm, or greater than about 150 ppm, or greater than about 250 ppm, or greater than about 300 ppm, up to about 1000 ppm. Additionally or alternatively, if citric acid is employed, then it is usually not employed alone but with a breaking composition such as those described in US2025/0250478 and U.S. Pat. No. 12,528,982. Alternatively or additionally, in some instances when employing citric acid then it may be useful to also employ EDTA or another chelating agent with the citric acid.

The selected conditions for introducing and/or contacting the one or more chelating agents and the produced fluid may vary. As described above, the chelating agent may be employed when the produced fluid may have more than 10 ppm of metal such as iron or any time that an emulsion may be strengthened by the presence of metals such as iron. Under such conditions a combination of flowback fluid and iron may tend to worsen emulsion issues leading to problematic emulsions that are relatively stable, e.g., take over 3 minutes to break. Generally, higher temperatures may facilitate emulsion breaking. Thus, when reservoir temperature is elevated, then less chelating agent and/or breaking compositions such as those in US2025/0250478 and U.S. Pat. No. 12,528,982 may be employed. Generally, the chelating agent, amount, and/or any breaking composition are employed such that water in oil is less than about 2 wt. percent, preferably less than about 1 wt. percent, after introducing one or more suitable treatments.

The amount of chelating agent employed (except citric acid as described above) is generally that molar amount which is approximately the same or greater than the emulsion stabilizing amount of one or more metal ions. In some embodiments the chelating agent is introduced in a molar amount of from about 1 times, or from about 2 times, or from about 3 times, up to about 5 times, or up to about 7 times, or up to about 8 times, or up to about 10 times, or up to about 15 times or more the molar amount of the emulsion stabilizing amount of one or more metal ions that is present in the produced fluid.

### Emulsion and Foam Breakers

The emulsion breakers and form breakers employed are not particularly critical so long as they are compatible with the chelating agents employed and facilitate reduction and/or elimination of the foams and/or emulsions formed. Typically, the specific emulsion breaker may be tailored to the specific chemistry of the crude oil, produced water, salinity, temperature, and operational conditions at the field. Suitable commercial emulsion breakers that may be useful herein include, for example, phenolic resin demulsifiers, epoxy resin demulsifiers, polyamine-based demulsifiers, alcohol- and glycol-based demulsifiers, and any mixture thereof. Suitable commercial product lines may include Emulsion Breakers™, Basolon™, Basomulsion™, and BasoBreak™ from Baker Hughes, ChampionX products like the DEMULSIFIER™ series and EC Series, Clariant Oil Service product lines called PHASETREAT™ and OLEOFIN™, Schlumberger's PETROFLO™ and DEMUL™ products, Innospec's DEH™ Demulsifiers, BASF's Lutensol® and Basorol® product lines, Croda's Hydramul™ and Synperonic™ products, and/or Dorf Ketal's Aegis™ and Korvas™ product lines.

Other suitable emulsion and foam breakers include those in, for example, US2025/0250478 and US2021/0179930 which are each incorporated herein by reference. These breaking compositions may comprise an agent with an octanol/water partition coefficient ([P]) at 25°, and wherein the log of the partition coefficient at 25° (log[P]) is from 0.1 to 5. Such agents may include, for example, a partitioning agent, a solvent, or a mixture thereof. Breaking compositions comprising a sulfosuccinate may also be useful with the chelating agents described herein.

### Comparative Example 1 without Chelating Agent

A solution of 0.5% by weight EGBE (Ethylene Glycol Monobutyl Ether, also known as 2-butoxyethanol) and 0.2% by weight of a commercially available emulsion breaker (20% or more alkyl benzenesulfonic acid, 10% or more light aromatic naphtha, 12% or more trimethylbenzenes, 5% or more methanol, 1% or more xylene, and 1% of less of each of cumene, sulfuric acid, and ethylbenzene) was made and compared with Example 1 for emulsion breaking of field sample emulsions.

### Example 1—with EDTA (Ethylenediaminetetraacetic Acid) Chelating Agent

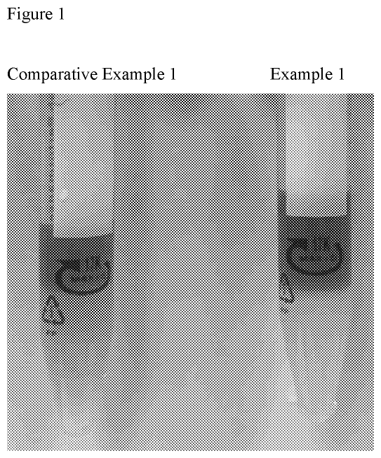

A solution of 0.5% by weight EGBE (Ethylene Glycol Monobutyl Ether, also known as 2-butoxyethanol) and 0.2% by weight of a commercially available emulsion breaker (20% or more alkyl benzenesulfonic acid, 10% or more light aromatic naphtha, 12% or more trimethylbenzenes, 5% or more methanol, 1% or more xylene, and 1% of less of each of cumene, sulfuric acid, and ethylbenzene) and 0.2% by weight EDTA chelating agent was made and compared with Comparative Example 1 for emulsion breaking of field sample emulsions. After 7 minutes the Example 1 sample with EDTA exhibited significantly more emulsion breaking as shown in FIG. 1.

### Comparative Example 2, 3, and 4 with Co-Solvents

Three different co-solvents were added at 0.5% by weight to three different solutions of Example 1 with 0.2% by weight EDTA chelating agent. The three co-solvents were IBA (isobutyl alcohol), EGBE (ethylene glycol monobutyl ether), and 4M2P (4-methyl-2-pentanol). None of the co-solvents showed an increase in emulsion breaking time of field sample emulsions.

### Example 2—B9 Emulsion Breaker with and without EDTA Chelating Agent

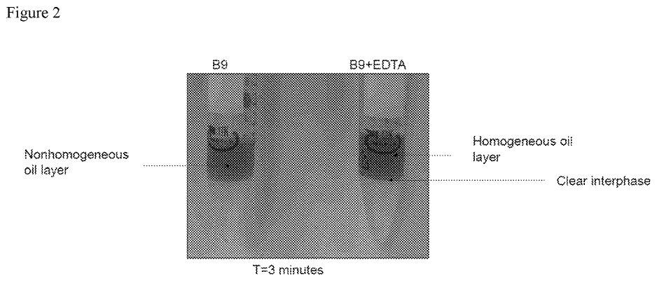

A solution of 0.5% by weight of an emulsion breaker B9 based on a composition described in US2025/0250478 and 0.2% by weight EDTA chelating agent was tested for emulsion breaking of field sample emulsions. B9 emulsion breaker comprises 19.51 wt. % of a sulfosuccinate, 73.17 wt. % 4-methyl-2-pentanol, 2.44% wt. % glycerol, and 4.88 wt. % solvent/others. As shown in FIG. 2, after three minutes the sample with only B9 seems to have a non-homogenous oil layer while the sample with B9 and EDTA chelating agent generates a homogeneous oil layer with a clear interphase.

### Example 3—B9-V1 Emulsion Breaker with and without Chelating Agent A

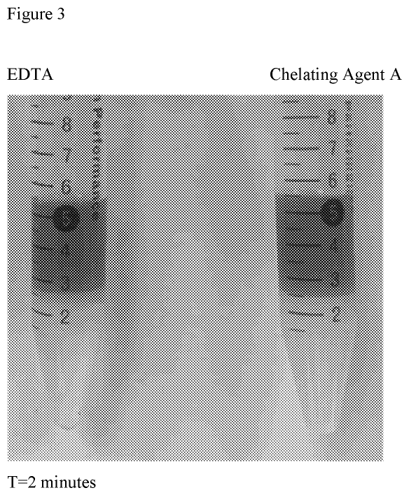

A solution of 0.3% by weight of an emulsion breaker B9-V1 based on a composition described in US2025/0250478 and 0.2% by weight Chelating Agent A (65-85% water, 15-35% tetrakis(hydroxymethyl phosphonium chloride) and <1% formaldehyde) was tested for emulsion breaking of field sample emulsions. B9-V1 emulsion breaker comprises 20 wt. % of a sulfosuccinate, 75 wt. % 4-methyl-2-pentanol, and 5 wt. % solvent/others. As shown in FIG. 3, after two minutes the sample with the chelating agent appears to break the emulsion faster.

### Example 4—B9-V1 Emulsion Breaker with and without Chelating Agent A or EDTA Chelating Agent

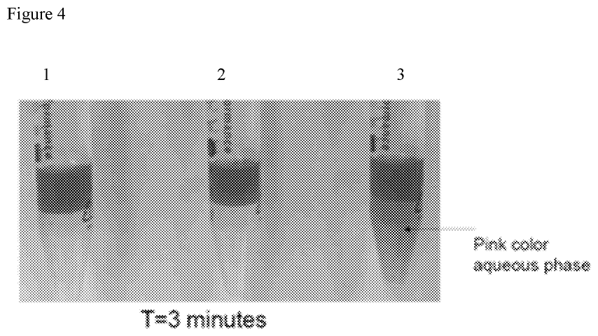

A solution of 0.3% by weight of an emulsion breaker B9-V1 based on a composition described in US2025/0250478 and 0.2% by weight Chelating Agent A (65-85% water, 15-35% tetrakis(hydroxymethyl phosphonium chloride) and <1% formaldehyde) was tested for emulsion breaking of field sample emulsions with 50 ppm iron added. Another solution of 0.3% by weight of a proprietary emulsion breaker B9-V1 and 0.2% by weight EDTA chelating agent was also tested with 50 ppm iron added. A comparative example had no chelating agent. As shown in FIG. 4, after three minutes the two samples with the chelating agent appear to give very sharp interphase compared to the sample without the chelating agent. The sample with Chelating Agent A appears to give a light pink color to the aqueous phase when iron is present. FIG. 4 shows the following samples:

| Sample # | Treated Combination |
|---|---|
| 1 | Fe + B9-V1 |
| 2 | Fe + B9-V1 + EDTA |
| 3 | Fe + B9-V1 + Chelating Agent A |

### EMBODIMENTS

1. A method of breaking or inhibiting the formation of a foam, an emulsion, or any combination thereof, the method comprising:
introducing a composition comprising a chelating agent into a produced fluid from the subterranean formation at, for example, the wellhead and/or produced fluid flow line, to contact the produced fluid under conditions sufficient to break or inhibit the formation of a foam, an emulsion, or any combination thereof.
2. The method of embodiment 1 wherein the composition comprising the chelating agent is introduced prior to introducing a breaking composition.
3. The method of embodiment 1 wherein the composition comprising the chelating agent is introduced simultaneously with introducing a breaking composition.
4. The method of embodiment 1 wherein a produced fluid from the subterranean formation comprises or is expected to comprise an emulsion stabilizing amount of one or more metal ions.
5. The method of embodiment 4 wherein the one or more metal ions comprises a ferrous ion or a ferric ion.
6. The method of embodiment 4 wherein the emulsion stabilizing amount of one or more metal ions comprises greater than about 10 ppm of metal ions in the produced fluid.
7. The method of embodiment 4 wherein the emulsion stabilizing amount of one or more metal ions comprises greater than about 20 ppm of metal ions in the produced fluid.
8. The method of embodiment 4 wherein the emulsion stabilizing amount of one or more metal ions comprises greater than about 20 ppm of iron ions.
9. The method of embodiment 1 wherein the chelating agent comprises an iron chelating agent.
10. The method of embodiment 9 wherein the iron chelating agent comprises ethylenediaminetetraacetic acid, tetrakis (hydroxymethyl) phosphonic acid, diethylenetriaminepentaacetic acid, glutamic acid diacetic acid, and methylglycine diacetic acid, citric acid, aminotris(methylenephosphonic acid), 1-hydroxyethylidene-1,1-diphosphonic acid, diethylenetriaminepenta(methylenephosphonic acid), or any salts or mixtures thereof.
11. The method of embodiment 9 wherein the iron chelating agent comprises ethylenediaminetetraacetic acid, tetrakis (hydroxymethyl) phosphonium chloride, or any mixture thereof.
12. The method of embodiment 4 wherein the chelating agent is introduced in a molar amount that is approximately the same or greater than the emulsion stabilizing amount of one or more metal ions.
13. The method of embodiment 4 wherein the chelating agent is introduced in a molar amount of from about 1 to about 10 times the molar amount of the emulsion stabilizing amount of one or more metal ions that is present in the produced fluid.
14. The method of embodiment 13 wherein the chelating agent comprises ethylenediaminetetraacetic acid, tetrakis (hydroxymethyl) phosphonium chloride, or any mixture thereof.
15. The method of embodiment 2 wherein the breaking composition comprises an agent with an octanol/water partition coefficient ([P]) at 25°, and wherein the log of the partition coefficient at 25° (log[P]) is from 0.1 to 5.
16. The method of embodiment 15 wherein the agent is a partitioning agent, a solvent, or a mixture thereof.
17. The method of embodiment 15 wherein the breaking composition further comprises a sulfosuccinate.
18. A reaction mixture comprising:
(1) a foam, an emulsion, or any combination thereof;
(2) produced fluid;
(3) a breaking agent;
(4) an emulsion stabilizing amount of one or more metal ions; and
(5) one or more chelating agents wherein the total amount of chelating agents is in a molar amount of from about 1 to about 10 times the molar amount of the emulsion stabilizing amount of one or more metal ions.
19. The reaction mixture of embodiment 18 wherein the emulsion stabilizing amount of one or more metal ions comprises at least about 10 ppm of iron ions.
20. The reaction mixture of embodiment 18 wherein the chelating agent comprises ethylenediaminetetraacetic acid, tetrakis (hydroxymethyl) phosphonium chloride, or any mixture thereof and wherein the breaking composition comprises an agent with an octanol/water partition coefficient ([P]) at 25°, and wherein the log of the partition coefficient at 25° (log[P]) is from 0.1 to 5.
21. A method of breaking a foam, emulsion, or any combination thereof, the method comprising:
contacting the foam, emulsion, or any combination thereof with a breaking composition and a chelating agent, wherein the breaking composition comprises a sulfosuccinate and a solvent;
   wherein the solvent has an octanol/water partition coefficient ([P]) at 25°, and wherein the log of the partition coefficient at 25° (log[P]) is from 0.1 to 5.
22. The method of embodiment 21 wherein the chelating agent comprises EDTA.

What is claimed is:

1. A method of breaking or inhibiting the formation of a foam, an emulsion, or any combination thereof, the method comprising:
introducing a composition comprising a chelating agent into a produced fluid from the subterranean formation at well head or produced fluid flow line to contact the produced fluid under conditions sufficient to break or inhibit the formation of a foam, an emulsion, or any combination thereof.

2. The method of claim 1 wherein the composition comprising the chelating agent is introduced prior to introducing a breaking composition into the produced fluid flow line from the subterranean formation.

3. The method of claim 1 wherein the composition comprising the chelating agent is introduced simultaneously with introducing a breaking composition into the produced fluid from the subterranean formation.

4. The method of claim 1 wherein a produced fluid from the subterranean formation comprises or is expected to comprise an emulsion stabilizing amount of one or more metal ions.

5. The method of claim 4 wherein the one or more metal ions comprises a ferrous ion or a ferric ion.

6. The method of claim 4 wherein the emulsion stabilizing amount of one or more metal ions comprises greater than about 10 ppm of metal ions in the produced fluid.

7. The method of claim 4 wherein the emulsion stabilizing amount of one or more metal ions comprises greater than about 20 ppm of metal ions in the produced fluid.

8. The method of claim 4 wherein the emulsion stabilizing amount of one or more metal ions comprises greater than about 20 ppm of iron ions in the produced fluid.

9. The method of claim 1 wherein the chelating agent comprises an iron chelating agent.

10. The method of claim 9 wherein the iron chelating agent comprises ethylenediaminetetraacetic acid, tetrakis (hydroxymethyl) phosphonic acid, diethylenetriaminepentaacetic acid, glutamic acid diacetic acid, and methylglycine diacetic acid, citric acid, aminotris(methylenephosphonic acid), 1-hydroxyethylidene-1,1-diphosphonic acid, diethylenetriaminepenta(methylenephosphonic acid), or any salts or mixtures thereof.

11. The method of claim 9 wherein the iron chelating agent comprises ethylenediaminetetraacetic acid, tetrakis (hydroxymethyl) phosphonium chloride, or any mixture thereof.

12. The method of claim 4 wherein the chelating agent is introduced in a molar amount that is approximately the same or greater than the emulsion stabilizing amount of one or more metal ions.

13. The method of claim 4 wherein the chelating agent is introduced in a molar amount of from about 1 to about 10 times the molar amount of the emulsion stabilizing amount of one or more metal ions that is present in the produced fluid.

14. The method of claim 13 wherein the chelating agent comprises ethylenediaminetetraacetic acid, tetrakis (hydroxymethyl) phosphonium chloride, or any mixture thereof.

15. The method of claim 2 wherein the breaking composition comprises an agent with an octanol/water partition coefficient ([P]) at 25°, and wherein the log of the partition coefficient at 25° (log[P]) is from 0.1 to 5.

16. The method of claim 15 wherein the agent is a partitioning agent, a solvent, or a mixture thereof.

17. The method of claim 15 wherein the breaking composition further comprises a sulfosuccinate.

18. A reaction mixture comprising:
(1) a foam, an emulsion, or any combination thereof;
(2) produced fluid;
(3) a breaking agent;
(4) an emulsion stabilizing amount of one or more metal ions; and
(5) one or more chelating agents wherein the total amount of chelating agents is in a molar amount of from about 1 to about 10 times the molar amount of the emulsion stabilizing amount of one or more metal ions.

19. The reaction mixture of claim 18 wherein the emulsion stabilizing amount of one or more metal ions comprises at least about 10 ppm of iron ions.

20. The reaction mixture of claim 18 wherein the chelating agent comprises ethylenediaminetetraacetic acid, tetrakis (hydroxymethyl) phosphonium chloride, or any mixture thereof and wherein the breaking agent comprises an agent with an octanol/water partition coefficient ([P]) at 25°, and wherein the log of the partition coefficient at 25° (log[P]) is from 0.1 to 5.

21. A method of breaking a foam, emulsion, or any combination thereof, the method comprising:
contacting the foam, emulsion, or any combination thereof with a breaking composition and a chelating agent, wherein the breaking composition comprises a sulfosuccinate and a solvent;
wherein the solvent has an octanol/water partition coefficient ([P]) at 25°, and wherein the log of the partition coefficient at 25° (log[P]) is from 0.1 to 5.

22. The method of claim 21 wherein the chelating agent comprises EDTA.
